(19) United States
(12) Patent Application Publication
(10) Pub. No.: US 2007/0046787 A1
(43) Pub. Date: Mar. 1, 2007

(54) Chrominance filter for white balance statistics

(75) Inventor: John Sasinowski, San Jose, CA (US)

Correspondence Address: DICKSTEIN SHAPIRO LLP, 1825 EYE STREET NW, Washington, DC, 20006-5403, US

(73) Assignee: Micron Technology, Inc.

(21) Appl. No.: 11/213,939

(22) Filed: Aug. 30, 2005

(51) Int. Cl. H04N 9/73

(52) U.S. Cl. 348/223.1

(57) ABSTRACT

A chrominance filter for excluding certain pixels from being included in a white balance calculation. By comparing a target pixel to predetermined maximum values of blue, red, magenta and green, a chrominance filter can selectively include pixels in the white balance correction calculation.

### FIELD OF THE INVENTION

The invention relates generally to digital image processing and more particularly to a method and apparatus for determining white balance correction in digital image processing.

### BACKGROUND OF THE INVENTION

Currently, there is a great demand for digital cameras. Commensurate with this demand is the demand for greater accuracy, i.e., “realism,” in images captured by digital cameras. Part of this realism is steeped in the desire to have the digital images reflective of how a person perceives the same image. However, reflecting this realism can be difficult.

After a digital camera captures a digital image, the circuitry within the camera performs image processing to make the image more realistic.

Color balance is the process of removing unrealistic color casts, so that the objects in a captured image are reflective of the perceived color. Color balance is achieved by balancing a captured image so that the image color is the same or close to the same as the image color perceived by the human visual system. For instance white balance is the process of removing unrealistic color casts due to the light source, so that white objects appear white in a captured image. Typically, when processing color in a digital image, the image may go through a series of processing steps, one of which is the white balance step.

An imaging processing system may apply a series of tests to determine the correct white balance for an image. One known approach to determining an automatic white balance uses the gray world model. The gray world model is premised on the entire image balancing out to gray, i.e., the average color of the image balancing out to gray, where gray is equivalent amounts of red, green, and blue signal values.

Based on this assumption, the signals received from pixels can be modified to be consistent with the gray world average. If the signals from the pixels are averaged together and the averaged color result is somewhat blueish, then compensation must be applied to make the reduce the blueish tint. This is commonly done when converting images that are taken under incandescent light (which are somewhat reddish) and compensating them by converting the reddish cast to gray.

However, the gray world model can be thrown off inherently by the subject matter of the image being taken. For example, if the image is a picture taken of a blue sky, the image really should average out to a predominance of blue, not gray. Additionally, if the picture is taken of grass, the image really should average out to a predominance of green, not gray. So there must be some other type of compensation when processing the digital signals. Furthermore, light sources are typically reddish or blueish, i.e., sunlight is blueish and incandescent light is often reddish.

Although mechanisms currently exist to compensate for color cast in a particular direction, the compensation often leads to detrimental side effects. For example, when processing a digital image containing green grass and a gray sidewalk, the compensation for the predominance of green grass would turn the sidewalk magenta. In general, it is known that green should generally be excluded because of the typical inherent colors of light sources (e.g., red and blue). This would address a great number of problems that occur for pictures taken outside. Magenta also should be partially excluded as complementary. So it would be desirable to have a filter that can be adjusted depending on the image being captured to exclude green and magenta colors when appropriate.

Therefore, it is desirable to have a white balance test that excludes certain pixels from the white balance correction computation for certain image conditions.

### BRIEF SUMMARY OF THE INVENTION

The present invention relates to an improved chrominance filter that selectively excludes pixels from the white balance correction. A YUV (i.e., luminance-chrominance) representation of a pixel is compared to an acceptable region that is defined by maximum and minimum values of U+V (i.e., blue chrominance+red chrominance) and U−V (i.e., blue chrominance−red chrominance) and if the pixel is within the acceptable region, the pixel is included in the white balance correction calculation. Because the filter requires a relatively simple calculation, only a few additional circuits are required to implement the filter and the size of the image processing system is not significantly increased.

### BRIEF DESCRIPTION OF THE DRAWINGS

The foregoing and other advantages and features of the invention will become more apparent from the detailed description of exemplary embodiments provided below with reference to the accompanying drawings in which:

FIG. 1 illustrates an imaging device according to an exemplary embodiment of the invention;

FIG. 2 illustrates a targeted colorspace of the imaging device of FIG. 1;

FIG. 3 illustrates a portion of the imaging device of FIG. 1 in greater detail; and

FIG. 4 is a block diagram showing a processor system incorporating at least one imaging device constructed in accordance with an embodiment of the invention.

### DETAILED DESCRIPTION OF THE INVENTION

In the following detailed description, reference is made to the accompanying drawings, which are a part of the specification, and in which is shown by way of illustration various embodiments whereby the invention may be practiced. These embodiments are described in sufficient detail to enable those skilled in the art to make and use the invention. It is to be understood that other embodiments may be utilized, and that structural, logical, and electrical changes, as well as changes in the materials used, may be made without departing from the spirit and scope of the present invention.

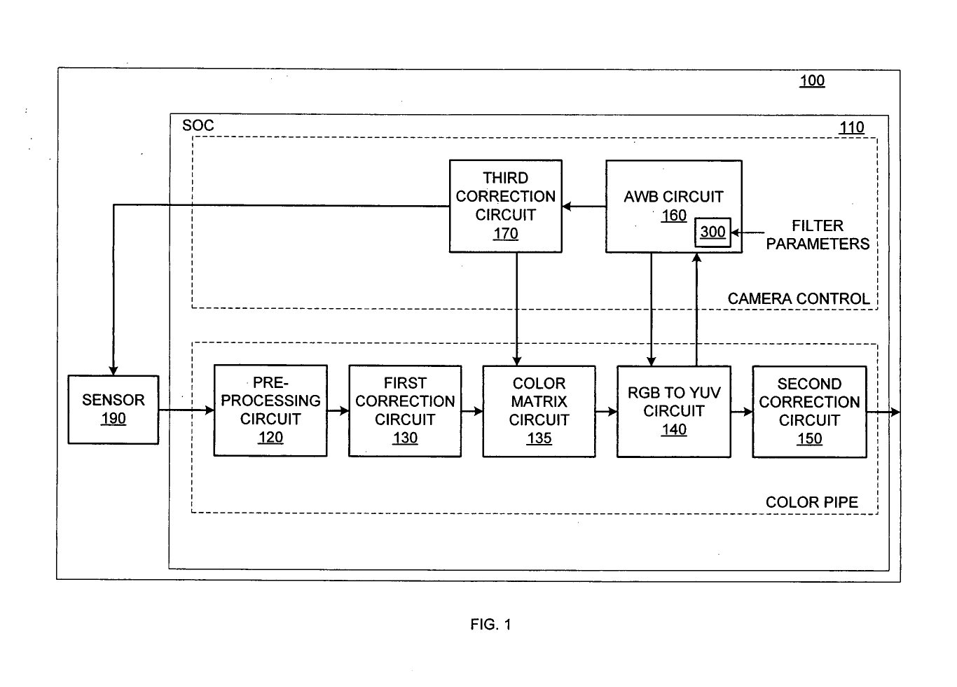

FIG. 1 illustrates an exemplary embodiment of the imaging processing device 100 of the invention, i.e., a digital camera, that includes an image sensor 190 and an imaging processing circuit 110. The imaging processing circuit 110 further includes a pre-processing circuit 120, a first image correction circuit 130, a RGB to YUV conversion circuit 140, second image correction circuit 150, an auto white balance correction circuit (“AWB”) 160, a third image correction circuit 170, and color matrix correction circuit 135.

The image sensor 190 is a sensor as is conventionally known and may be any type of solid state images including CMOS, CCD and others. One exemplary image sensor 190 is a CMOS image sensor with active pixel sensors (“APS”). As is conventionally known, the image sensor 190 receives image information in the form of photons, and converts that information to pixel analog electrical signals, which are subsequently provided to down stream processing circuits. In the imaging processing device 100, the image sensor 190 provides electrical signals to the image processing circuit 110.

The pre-processing circuit 120 performs an initial processing to the raw image data received from the image sensor 190. In a preferred embodiment, the pre-processing circuit 120 includes an analog-to-digital conversion circuit. The pre-processing circuit 120 may also include one (or a plurality of cascaded) gain stage circuit(s) and one (or a plurality of cascaded) amplifier circuit(s). The pre-processing circuit 120 outputs a digital signal corresponding to the analog signal received from the image sensor 190.

The first image correction circuit 130 performs a first level of processing to the digital signal received from the pre-processing circuit 120. The first image correction circuit 130 may include circuits that perform image defect correction, mosaic effects correction, image resizing, aperture correction, and correction for other effects or defects. In a preferred embodiment, the pre-processing circuit 120 outputs are RGB representational of the image data from red, blue and green pixels of sensor 190.

The color matrix circuit 135 receives the RGB signals from the first image correction circuit 130 and applies matrix modifications to the signals. The matrix modifications can include correction for color balance. The color matrix circuit 135 receives from the third image correction circuit 170 matrix modification coefficients. The color matrix circuit 135 provides modified RGB signals to the RGB-to-YUV conversion circuit 140.

The RGB-to-YUV conversion circuit 140 converts the RGB data structures into a second set of data structures in YUV format that are also representational of the RGB data. YUV, as is conventionally known, stores image data in Y-luminance (“luma”), U-blue chrominance (“blue chroma” or “Cb”) and V-red chrominance (“red chroma” or “Cr”). The RGB-to-YUV conversion circuit 140 provides the two sets of data structures, RGB and YUV data structures, to the AWB circuit 160. The RGB-to-YUV conversion circuit 140 receives white balance correction signals from the AWB circuit 160. The RGB-to-YUV conversion circuit 140 provides the two data structures, RGB and YUV, and the white balance correction signals received from the AWB circuit 160 to the second image correction circuit 150.

The second image correction circuit 150 performs a second level of processing to the digital signals received from the RGB-to-YUV conversion circuit 140. The second image correction circuit 150 may include circuits that perform white balance correction, gamma correction, pixel formatting and correction for other effects or defects. In a preferred embodiment, the second image correction circuit 150 outputs an RGB data structure representational of the image data of red, blue and green pixels. Alternatively, the second image correction circuit 150 outputs a data stream of digital information for further processing in down stream circuitry.

The AWB circuit 160 receives image data, in the form of the data structures RGB and YUV and computes the correction values, if required, to perform white balancing. The AWB circuit 160 computation of the appropriate white balance correction is explained in greater detail below. The AWB circuit 160 provides the results of its computation to the RGB-to-YUV conversion circuit 140 and to the third image correction circuit 170. The AWB circuit 160 uses either the RGB or the YUV data structures separately, or in combination, depending on the computation the AWB circuit 160 is conducting. The improved chrominance filter of the present invention resides in the AWB circuit 160.

It is preferable to perform the white balance computation in the AWB circuit 160 using the YUV data structure because of the inherent properties of the YUV data structure. As is known, the YUV data structure breaks down an image into the Y, the luminance values, and YUV, which is essentially a two-dimensional representation of color, where the two color components are U and V (i.e., Cb and Cr).

The third image correction circuit 170 receives information from the AWB circuit 160 and determines new settings for color matrix coefficients, which are provided to the color matrix circuit 135. The third image correction circuit 170 also calculates gain ratios, light compensation coefficients, and saturation/desaturation coefficients and provides those values to the sensor 190. In a preferred embodiment, the third image correction circuit 170 provides a single coefficient matrix which can reflect multiple corrections, where the matrix is generally a 3×3 (e.g., a three by three) matrix. The sensor 190 uses those values for control of capturing subsequent images. For example, the sensor 190 may use the light compensation coefficient to modify the image exposure time, i.e., the photo capture time period.

In an embodiment of the invention, circuits 120, 130, 135, 140, 150, 160, and 170 are implemented in hardware, preferably according to a system on a chip (“SOC”) configuration. Circuits 120, 130, 135, 140, and 150 are part of the “color pipe” of the imaging processing device 100. Circuits 160 and 170 are part of camera control of the imaging processing device 100.

As noted, above, one test used to determine the auto white balance correction of an image includes calculating pixels statistics in the image. For example, the number of red, blue, and green pixels are determined. The collected statistics are compared to expected values and the results of the comparison are used to correct the white balance. To avoid biasing the image (e.g., too much green), the improved chrominance filter excludes certain pixels from the automatic white balance computation.

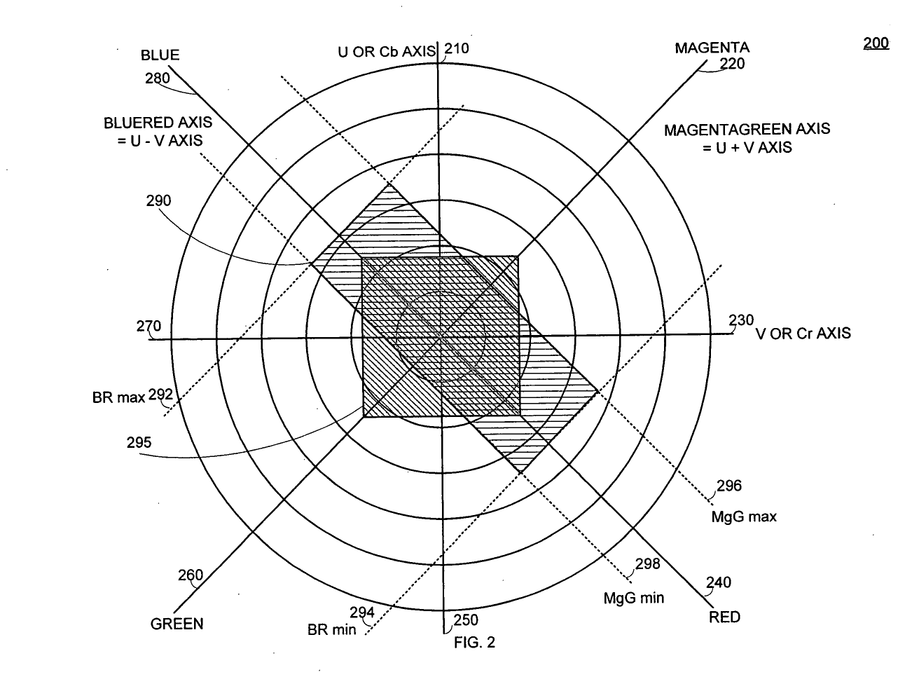

FIG. 2 illustrates the application of the improved chrominance filter of the present invention. FIG. 2 represents the potential colorspace 200 of a pixel in a captured digital image, having U, or Cb, and V, or Cr axes. The colorspace 200 includes the two main “XY” axes: U axis 210 (the positive aspect of the U axis)/250 (the negative aspect of the U axis) and V axis 230 (the positive aspect of the V axis)/270 (the negative aspect of the V axis). The colorspace 200 also include rotated axes: BlueRed (“BR”) axis 280 (the blue aspect of the BlueRed axis)/240 (the red aspect of the BlueRed axis) and MagentaGreen (“MgG”) axis 220 (the Magenta aspect of the MagentaGreen axis)/260 (the Green aspect of the MagentaGreen axis). Although BR axis 280/240 is shown midway between the U and V axes, this location is intended to contain an easily computable approximation to the chrominances of blue and red pixels. Further, although MgG axis 220/260 is shown midway between the U and V axes, this location is intended to be an easily computable approximation to the chrominances of magenta and green pixels.

FIG. 2 illustrates a first shaded region 290 which reflects the pixel values that are included, i.e., not filtered out, by the improved chrominance filter according to an exemplary embodiment of the present invention. Pixel values that are outside the first shaded region 290 are not included in the calculation of the white balance correction value. The first shaded region 290 is bounded in the MagentaGreen (“MgG”) regions by a maximum, MgG max 296, and a minimum, MgG min 298. The first shaded region 290 is bounded in the BlueRed region by a maximum, BR max 292, and a minimum, BR min 294. Further, the region 290 is not required to be centered around the origin formed by the U and V axes.

Also seen in FIG. 2 is a second shaded region 295, which reflects the pixel values that are included, i.e., not filtered out, by a conventional chrominance filter. Pixel values that are outside the second shaded region 295 are not included in the calculation of the white balance correction value. The second shaded region 295 is bounded in the U region by a max and min and is bounded in the V region by a max and minimum.

An advantage of the improved chrominance filter of the present invention is that the amount of Green and/or Magenta that is included in the white balance computation, i.e., the first shaded region 290, can be easily adjusted by changing the MgG min and max values. Furthermore, in the present invention the inclusion/exclusion of Green and/or Magenta by modifying MgG min and max reduces the collateral effect on the inclusion/exclusion of U and/or V. For example, to reduce the number of Green pixels included in the automatic white balance in a conventional approach (i.e., shaded region 295) requires reducing U and/or V, which directly linearly reduces the U and/or V. Additionally, significant circuitry is required to implement a change in the max/min boundaries of the green/magenta in the shaded region 295 as it would require changing the shape of the second shaded region 295 from being rectangularly shaped to, at least, pentagonally or hexagonally shaped.

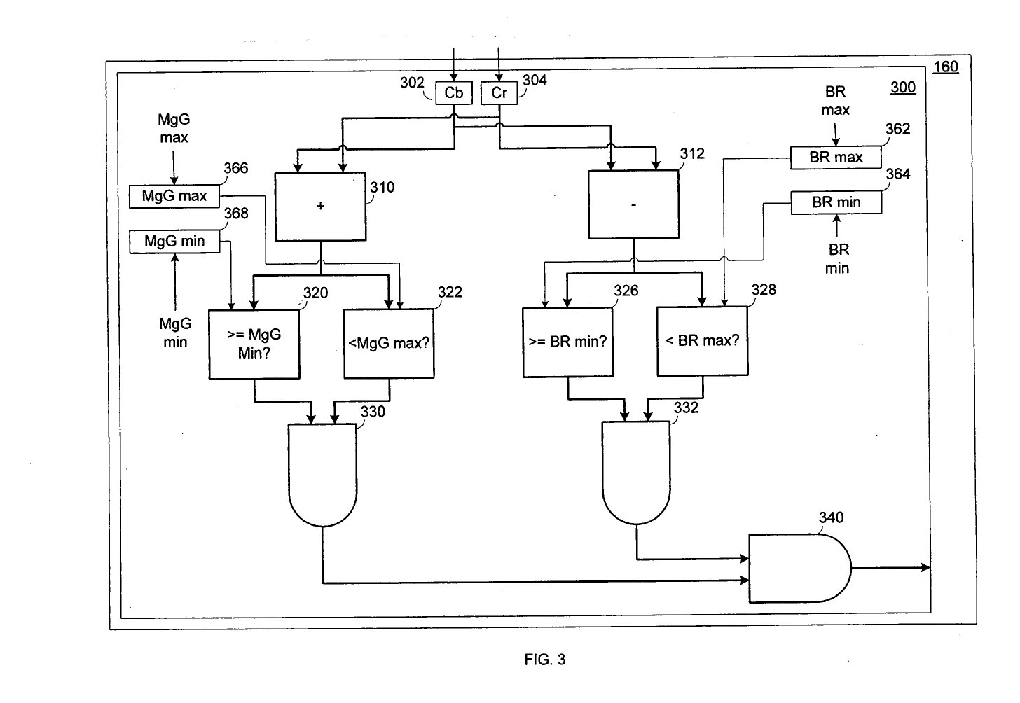

FIG. 3 is a block diagram illustrating a portion (e.g., chrominance filter circuit 300) of the AWB circuit 160 of FIG. 1 in greater detail. As noted above, in implementation of an AWB circuit 160, the chrominance filter circuit 300 of the present invention is one of potentially many tests or filters that are utilized by the AWB circuit 160 to determine the white balance of the digital image. The chrominance filter circuit 300 tests whether a pixel should be included or excluded from a white balance calculation by comparing the sum of U and V to MgG boundaries (i.e., MgG max, MgG min) and the difference of U and Y to the BR boundaries (i.e., BR max, and BR min).

The chrominance filter circuit 300 includes an addition circuit 310, a subtraction circuit 312, comparison circuits 320, 322, 326, 328, and AND circuits 330, 332, 340. Programmable registers 366, 368, 362, 364 store MgG max, MgG min, BR max, and BR min values, respectively. In a preferred embodiment, MgG max, MgG min, BR max, and BR min are values that are determined empirically and stored in the chrominance filter circuit 300. In another aspect, sets of values for MgG max, MgG min, BR max, and BR min are determined empirically for different types of lighting environments. For example, there is a first set of values for MgG max, MgG min, BR max, and BR min for pictures taken outdoors in full sunlight and a second set of values for pictures taken inside under incandescent light. In another aspect, values for MgG max, MgG min, BR max, and BR min are established by an end user, i.e., the camera operator.

The inputs to the chrominance filter circuit 300 are assigned chrominance values, i.e., U, V, of a target pixel. The chrominance values U, V are calculated in an upstream circuit (not shown) and stored in registers 302, 304, respectively, preferably in the chrominance filter circuit 300. The blocks 310, 312 perform signed addition and subtraction, respectively, to the chrominance values U, V. For example, block 310 adds U to V and provides the results of the computation to comparison blocks 320, 322. Comparison blocks 320, 322 compare, respectively, the input they receive from block 310 to the MgG min, MgGmax values. The results of comparison blocks 320, 322 are compared (i.e., ANDed together) in block 330.

Block 312 subtracts V from U and provides the results of the subtraction to comparison blocks 326, 328. Comparison blocks 326, 328 compare, respectively, the input they receive from block 312 to the BRmax, BRmin values. The results of comparison blocks 326, 328 are compared (i.e., ANDed together) in block 332. The results of blocks 330, 332 are compared (i.e., ANDed together) in block 340 and the output is provided to a downstream circuit. In a preferred embodiment, if the target pixel is within the first shaded region 290 (FIG. 2), then a logic TRUE signal is output from block 340. If the target pixel is not within the shaded region 290 (FIG. 2), then a logic FALSE signal is output from block 340. The target pixel is only considered desirable, i.e., falling within the first shaded region 290, if it passes all the comparisons of the circuit 300.

As the slope of U-V axis line is forty-five (45) degrees, this slope simplifies the computations of the boundaries of first shaded region 290 as, the trigonometric functions cancel out. Therefore, the boundaries can be implemented using simple ADDER circuit blocks (i.e., blocks 310, 312). If the slope of U-V axis line was not forty-five (45) degrees, additional circuitry would be required to compute which would increase the complexity and size of the circuit.

An advantage of the present invention is that certain colored pixels, e.g., green, can be excluded from the white balance computation without having a linear loss of collateral colored pixels. For example, in a conventional white balance filter (as seen as the second shaded region 295 in FIG. 2) reducing the green pixels in a desirable group of pixels directly and linearly reduces the red and blue pixels.

Another advantage of the present invention is that the shaded region is not required to be centered at the intersection of the U and V axes because of the programmable values for registers 362, 364, 366, 368. Thus, the boundary of the shaded region 290 in the direction of Magenta (MgG max) does not have to be equivalent to the boundary of the shaded region 290 in the direction of Green (MgG min) (i.e., absolute value (MgG max) does not have to equal absolute value (MgG min)). Additionally, the boundary of the shaded region 290 in the direction of Blue (BR max) does not have to be equivalent to the boundary of the shaded region 290 in the direction of Red(BR min) (i.e., absolute value (BR max) does not have to equal absolute value (BR min)).

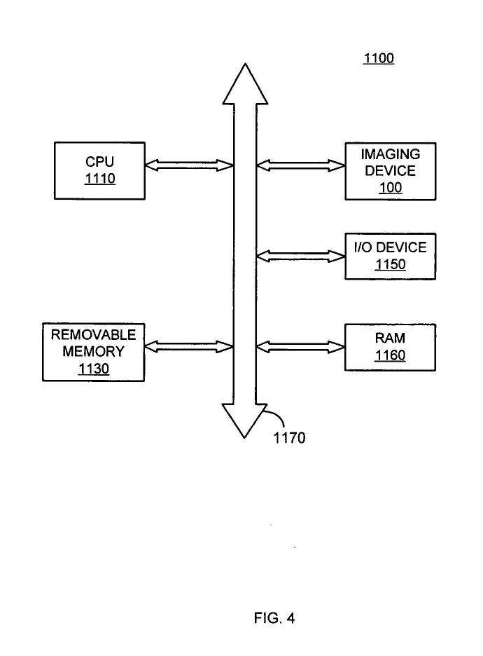

FIG. 4 shows a system 1100, a typical processor system modified to include an imaging processing device 100 (as constructed in FIG. 1). The system 1100 is exemplary of a system having digital circuits that could include image sensor devices. Without being limiting, such a system could include a computer system, camera system, scanner, machine vision, vehicle navigation, video phone, surveillance system, auto focus system, star tracker system, motion detection system, image stabilization system, and other image acquisition or processing system.

System 1100, for example a camera system, generally comprises a central processing unit (CPU) 1110, such as a microprocessor, that communicates with an input/output (I/O) device 1150 over a bus 1170. Imaging processing device 100 also communicates with the CPU 1110 over the bus 1170. The system 1100 also includes random access memory (RAM) 1160, and can include removable memory 1130, such as flash memory, which also communicate with the CPU 1110 over the bus 1170. The imaging processing device 100 may be combined with a processor, such as a CPU, digital signal processor, or microprocessor, with or without memory storage on a single integrated circuit or on a different chip than the processor.

It should be appreciated that other embodiments of the invention include a method of manufacturing the system 1100. For example, in one exemplary embodiment, a method of manufacturing an CMOS readout circuit includes the steps of providing, over a portion of a substrate corresponding to a single integrated circuit, at least an image sensor with an automatic white balance circuit (FIG. 1) as described above using known semiconductor fabrication techniques.

While the invention has been described and illustrated with reference to specific exemplary embodiments, it should be understood that many modifications and substitutions can be made without departing from the spirit and scope of the invention. Accordingly, the invention is not to be considered as limited by the foregoing description but is only limited by the scope of the claims.

What is claimed as new and desired to be protected by Letters Patent of the United States is:

1. A method of operating a digital camera, said method comprising:
acquiring an image using an image sensor; and
performing a white balance correction on said image using pixels selected by comparing pixel target values to an acceptable region of chrominance, where the acceptable region is defined by maximum and minimum values of combined chrominance values.

2. The method of claim 1, wherein one of said combined chrominance values is a BlueRed value.

3. The method of claim 2, wherein one of said combined chrominance values is a MagentaGreen value.

4. The method of claim 2, wherein said acceptable region is mapped in a luminance-chrominance colorspace

5. The method of claim 4, wherein said acceptable region is not centered on an intersection of a blue chrominance axis and a red chrominance axis in said luminance-chrominance colorspace.

6. The method of claim 1, further comprising the step of creating a luminance-chrominance representation of the image from the Red-Green-Blue representation.

7. The method of claim 1, further comprising the steps of:
defining the maximum and minimum values by determining empirically values of the combined chrominance values; and programming the values to define the acceptable region of chrominance.

8. The method of claim 1, further comprising the step of defining the maximum and minimum values by determining empirically the values based on different types of lighting environments.

9. The method of claim 1, wherein the performing step comprises maximum and minimum values established by a user.

10. A method of operating a digital camera, said method comprising:
acquiring an image using an image sensor; and
performing a white balance correction on said image using pixels selected by comparing pixel target values to an acceptable region of chrominance, where the acceptable region is bounded by a maximum magenta-green value, a minimum magenta-green value, a maximum blue-red value and a minimum blue-red value.

11. The method of claim 10, wherein the performing step does not include any value not within the accepted region in the white balance correction value.

12. A white balance filter comprising a circuit for receiving first and second chrominance values, comparing said first and second chrominance values to a designated region in a luminance-chrominance colorspace and excluding a pixel corresponding to the first and second chrominance values based on said comparison from a white balance correction calculation.

13. The filter of claim 12, further comprising:
first and second combining circuits for combining said first and second chrominance values.

14. The filter of claim 13, wherein said first combining circuit is adapted to add said first chrominance value to said second chrominance value and outputs an added chrominance value and said second combining circuit is adapted to subtract said second chrominance value from said first chrominance value and outputs a subtracted chrominance value.

15. The filter of claim 13, further comprising:
first and second comparison circuits for comparing said added chrominance value to maximum and minimum MagentaGreen values, respectively.

16. The filter of claim 15, further comprising:
third and fourth comparison circuits for comparing said subtracted chrominance value to maximum and minimum BlueRed values, respectively.

17. The filter of claim 16, further comprising:
first and second AND circuits for respectively ANDing the outputs of said first comparison circuit with said second comparison circuit and said third comparison circuit with said fourth comparison circuit.

18. The filter of claim 16, further comprising:
a third AND circuit for first and second AND circuits for respectively ANDing the outputs of said first and second AND circuits.

19. A system comprising:
a processor coupled to an image sensor and a white balance sensor, said white balance filter comprising:
a circuit for receiving first and second chrominance values, comparing said first and second chrominance values to a designated region in a luminance-chrominance colorspace and excluding a pixel corresponding to the first and second chrominance values based on said comparison from a white balance correction calculation.

20. The system of claim 19, further comprising:
first and second combining circuits for combining said first and second chrominance values.

21. The system of claim 20, wherein said first combining circuit is adapted to add said first chrominance value to said second chrominance value and outputs an added chrominance value and said second combining circuit is adapted to subtract said second chrominance value from said first chrominance value and outputs a subtracted chrominance value.

22. The system of claim 20, further comprising:
first and second comparison circuits for comparing said added chrominance value to maximum and minimum MagentaGreen values, respectively.

23. The system of claim 22, further comprising:
third and fourth comparison circuits for comparing said subtracted chrominance value to maximum and minimum BlueRed values, respectively.

24. The system of claim 19, further comprising:
first and second AND circuits for respectively ANDing the outputs of said first comparison circuit with said second comparison circuit and said third comparison circuit with said fourth comparison circuit.

25. The system of claim 19, further comprising:
a third AND circuit for first and second AND circuits for respectively ANDing the outputs of said first and second AND circuits.

26. A method of forming a white balance sensor within a digital camera, comprising the steps of:
forming a first circuit for receiving first and second chrominance values;
forming a combining circuit for combining the first and second chrominance values; and
forming a second circuit for determining new settings for the digital camera.
